(19) United States
(12) Patent Application Publication
(10) Pub. No.: US 2014/0149560 A1
(43) Pub. Date: May 29, 2014

(54) DYNAMIC TIME ZONE MANAGEMENT OF COMPUTING DEVICES

(71) Applicant: MICROSOFT CORPORATION, Redmond, WA (US)

(72) Inventors: Sina Hakami, Bothell, WA (US); Patrick Tousignant, Bellevue, WA (US); Juan Esteve Balducci, Sammamish, WA (US); Fabio Pintos, Kirkland, WA (US); Tom Millett, Mill Creek, WA (US)

(73) Assignee: MICROSOFT CORPORATION, Redmond, WA (US)

(21) Appl. No.: 13/685,693

(22) Filed: Nov. 26, 2012

(51) Int. Cl. G06F 15/177

(52) U.S. Cl. CPC G06F 15/177
USPC 709/221

(57) ABSTRACT

Various techniques of time zone conversion are disclosed in this application. For example, in one embodiment, a computing device can include a synchronizer configured to receive a set of time zone rules from a server. The set of time zone rules individually including a time zone identifier, a start date, and a time offset from a standard time beginning from the start date. The computing device can also include a converter operatively coupled to the synchronizer. The converter is configured to selectively convert time zone sensitive data received at or stored on the computing device to a target time zone based on the set of time zone rules.

### BACKGROUND

Today, users often travel with laptops, tablet computers, smartphones, and other computing devices from one time zone to another. Such time zone change may require conversion of meeting times, travel itineraries, and/or other user data stored on the computing devices. For example, a user traveling from New York to Berlin may desire to have his/her appointments displayed in Berlin time when in Berlin. Currently, computing devices use a set of built-in conversion rules to account for such time zone changes. The built-in rules may be pre-installed in operating systems, web browsers, or other applications.

However, authorities may occasionally or even frequently change time keeping rules in their respective countries. For example, Germany may decide to institute (or abolish) daylight saving time for a particular year. As a result, conversions to Berlin time based on the pre-installed built-in rules may be one hour earlier (or late) then actual local time in Berlin. Such discrepancies may cause missed meeting appointments, missed flights, and/or other inconveniences.

### SUMMARY

The present technology is directed to techniques for dynamically managing time zone conversions on computing devices. For example, one technique can include maintaining a set of current time zone settings on a server and generating a set of time zone rules based thereon. Each of the set of time zone rules can include a time zone identifier, a start date, and a time offset from a standard time beginning from the start date. Upon receiving a request from a client device, the server can transmit the set of time zone rules to the client device.

In accordance with another aspect of the present technology, the client device can convert certain user data based on the set of time zone rules received from the server. For example, the client device can compare a time zone of the user data to a target time zone of the client device. The target time zone may be a user selected time zone, an automatically detected time zone by the client device, or other suitably designated time zones. If the time zones do not match, the client device can convert a time stamp of the user data to the target time zone based on the set of time zone rules, instead of relying on local system time of the client device. As a result, the user data may have the correct time stamp irrespective of the accuracy of the local system time on the client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a schematic block diagram illustrating a computing framework in accordance with embodiments of the present technology.

FIG. 2 is a flow diagram illustrating a process for writing time zone sensitive data to a client device in accordance with embodiments of the present technology.

FIG. 3 is a flow diagram illustrating a process for reading time zone sensitive data stored in a client device in accordance with embodiments of the present technology.

FIG. 4 is a flow diagram illustrating a process for converting time stamps of time zone sensitive data in accordance with embodiments of the present technology.

### DETAILED DESCRIPTION

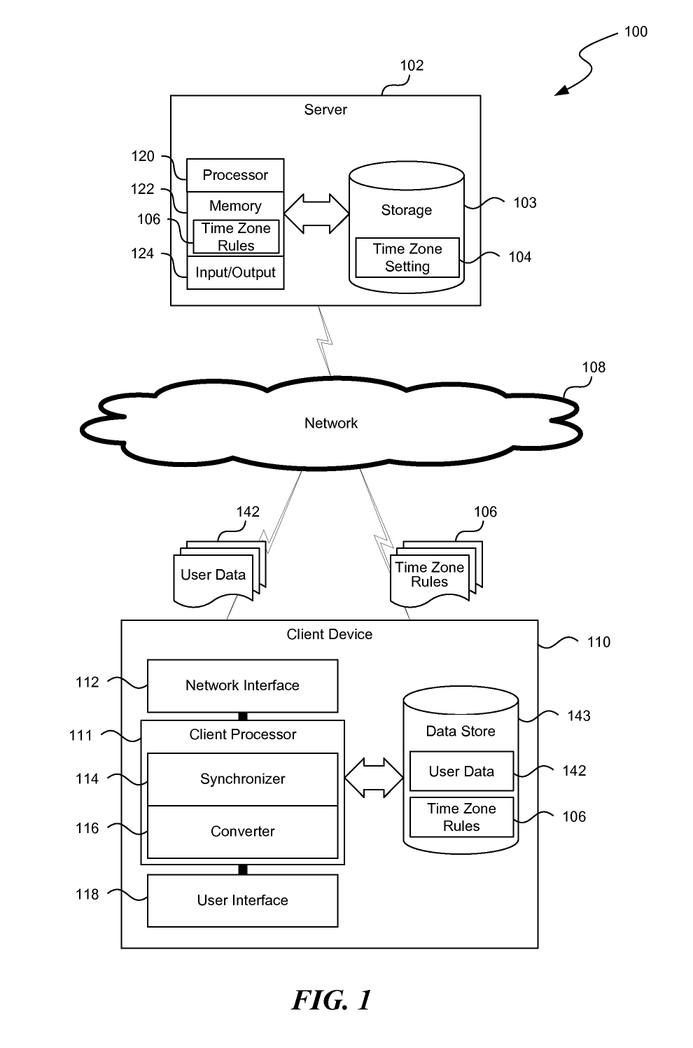

Various embodiments of systems, devices, components, modules, routines, and processes for dynamically managing time zone conversion are described below. In the following description, example software codes, values, and other specific details are included to provide a thorough understanding of various embodiments of the present technology. A person skilled in the relevant art will also understand that the technology may have additional embodiments. The technology may also be practiced without several of the details of the embodiments described below with reference to FIGS. 1-4.

As used herein, the term “time zone sensitive data” generally refers to data whose value may be affected by a time zone change. For example, time zone sensitive data can include an appointment date/time, a task due date, an email reception time, an email send time, a birthdate, and/or other suitable data. Also, as used herein, the term “standard time” generally refers to a time scale based on the rotation of the Earth. Examples of standard time include Coordinated Universal Time (“UTC”), Greenwich Mean Time (“GMT”), Universal Time 0 (“UT0”), Universal Time 1 (“UT1”), Universal Time 1R (“UT1R”), Universal Time 2 (“UT2”), Universal Time 2R (“UT2R”), and/or other suitable time scales.

As discussed above, authorities may occasionally or even frequently change time keeping rules in their respective countries. Such changes may cause local system time in client devices to be incorrect based on pre-installed built-in time zone conversion rules. To remedy such discrepancies, conventional techniques may require downloading an entire set of time zone sensitive data, updates to operating systems, web browsers, and/or other applications on the client devices. Such downloads can occupy limited communication bandwidths and/or storage capacity on the client devices. As discussed in more detail below, the present technology can address at least certain aspects of the foregoing difficulty by maintaining a set of current time zone rules on a server and synchronizes the rules between the server and client devices. As a result, the client devices may correctly convert time zone sensitive data irrespective of the accuracy of the local system time.

FIG. 1 is a schematic block diagram illustrating a computing framework 100 in accordance with embodiments of the present technology. As shown in FIG. 1, the computing framework 100 can include a server 102 and a client device 110 interconnected by a network 108. In one embodiment, the network 108 can be the Internet. In other embodiments, the network 108 can also include a personal area network, a local area network, a storage area network, a backbone network, a Metropolitan area network, a wide area network, a virtual private network, and/or other suitable types of network. Even though only the foregoing components are illustrated in FIG. 1, in other embodiments, the computing framework 100 can also include additional servers, client devices, networking devices, and/or other suitable components.

The server 102 can be an enterprise server (e.g., an Microsoft® Exchange server), a mail server, a web server, a cloud server, an application server, a catalog server, a communication server, and/or other suitable types of server. As shown in FIG. 1, the server 102 can include a processor 120, a memory 122, an input/output component 124, and a storage 103 interconnected to one another. The processor 120 can include a mainframe processor, a microprocessor, a field-programmable gate array, and/or other suitable logic devices. The memory 122 can include volatile and/or nonvolatile computer readable storage media (e.g., ROM, cache) excluding propagating signals. The memory 122 can be configured to store data received from, as well as instructions for, the processor 120. The input/output component 124 can include a display, a touch screen, a keyboard, a track ball, and/or other suitable types of input/output devices configured to accept input from and/or provide output to an operator and/or other computing components (not shown). The storage 103 can include magnetic disk storage media, optical storage media, flash memory drives, and/or other suitable persistent computer readable storage media excluding propagated signals.

As shown in FIG. 1, the storage 103 of the server 102 can contain records of time zone settings 104 individually including a time zone name, a time change date, a time change recurrence, an exception to the time change recurrence, and/or other suitable parameters. In one embodiment, the time zone settings 104 can be maintained in the storage 103 as a plurality of registry entries. For example, a portion of a registry entry for the Middle East time zone for a Windows™ operating system may appear as follows:

[HKEY_LOCAL_MACHINE\SOFTWARE\Microsoft\Windows
NT\CurrentVersion\Time Zones\Middle East Standard Time]
“Display”=“(UTC+02:00) Beirut”
“Dlt”=“Middle East Daylight Time”
“Std”=“Middle East Standard Time”
“MUI_Display”=“@tzres.dll,−363”
“MUI_Dlt”=“@tzres.dll,−364”
“MUI_Std”=“@tzres.dll,−365”

As shown above, the time zone settings 104 can include a location of the registry (i.e., “[HKEY_LOCAL_MACHINE . . . ”]), a display name (i.e., “(UTC+02:00) Beirut”), a daylight savings time field (i.e., “Dlt”), a standard time field (i.e., “Std”), and multiple user interface display settings (i.e., “MUI_Display,” “MUI_Dlt,” and “MUI_Std”). In other embodiments, the registry entry may also include a plurality of entries for dynamic daylight savings time settings (not shown) and/or other suitable entries. In further embodiments, the storage 103 may maintain the time zone settings 104 as database records, as XML files, as text files, and/or as other suitable data records.

The processor 120 can generate the time zone rules 106 based on the time zone settings 104. In one embodiment, the processor 120 can generate the time zone rules 106 each time upon receiving a request from the client device 110 or from other client devices (not shown) for the time zone rules 106. In another embodiment, the processor 120 can generate the time zone rules 106 upon receiving a first request from the client device 110 and store the generated time zone rules 106 in the memory 122 (e.g., cache). Upon receiving subsequent requests, the server 102 may provide the time zone rules 106 stored in the memory 122. In yet another embodiment, the processor 120 can generate the time zone rules 106 periodically (e.g., every hour, day, week, month, year, etc.) and store the generated time zone rules 106 in the memory 122. In further embodiments, the processor 120 can generate the time zone rules 106 upon a startup of the processor 120 or based on other arrangements.

In certain embodiments, the processor 120 can generate the time zone rules 106 by extracting at least one of a time zone identifier, a start date, and a time offset from a standard time beginning from the start date based on the time zone settings 104. For example, one of the time zone rules 106 for the Middle East time zone may be expressed in JavaScript Object Notation (“JSON”) as follows:

“TimeZoneId”:“Middle East Standard Time,”,
“OffsetRanges”:

[
{“Offset”:120,“UtcTime”:“2010-01-01T00:00:00.000Z”},
{“Offset”:180,“UtcTime”:“2010-03-27T21:59:59.999Z”},
{“Offset”:120,“UtcTime”:“2010-10-30T20:59:59.999Z”},
{“Offset”:180,“UtcTime”:“2011-03-26T21:59:59.999Z”},
{“Offset”:120,“UtcTime”:“2011-10-29T20:59:59.999Z”},
{“Offset”:180,“UtcTime”:“2012-03-24T21:59:59.999Z”},
{“Offset”:120,“UtcTime”:“2012-10-27T20:59:59.999Z”},
{“Offset”:180,“UtcTime”:“2013-03-30T21:59:59.999Z”},
{“Offset”:120,“UtcTime”:“2013-10-26T20:59:59.999Z”}
]

As shown above, the example time zone rule 106 includes the time zone identifier (i.e., “TimeZoneId” with a value of “Middle East Standard Time”) and a plurality of time offsets for various start dates. For example, on Jan. 1, 2010, the offset of the Middle East Standard Time is 120 minutes from UTC. On Mar. 27, 2010, the offset becomes 180 minutes from UTC. On Nov. 10, 2010, the offset reverts to 120 minutes from UTC.

In other embodiments, the time zone rules 106 may include the same or different arrangements of the foregoing and/or additional data (not shown). For example, the offsets may be expressed as date spans with a beginning date and an end date. In the example above, the offset between Jan. 1, 2010 and march 27, 2010 may be expressed as follows:

### {“Offset”:120,“UtcTime”:“2010-01-01T00:00:00.000Z”, “2010-03-27T21:59:59.999Z”}

In further embodiments, the storage 103 may maintain the time zone rules 106 in other suitable arrangements as JSON records, comma separated values, as XML files, as text files, and/or as other suitable files. Even though the generated time zone rules 106 are showing in FIG. 1 as stored in the memory 122 (e.g., cache) for fast access, in other embodiments, the time zone rules 106 can also be stored in the storage 103 and/or in other suitable storage locations.

In certain embodiments, the client device 110 can include a desktop, a laptop, a tablet computer, a smartphone, and/or other suitable types of computing device. In other embodiments, the client device 110 may also include a software service (e.g., Gmail Web service) running on any of the foregoing or other types of computing devices. As shown in FIG. 1, the client device 110 can include a network interface 112, a client processor 111, a user interface 118, and a data store 143 interconnected to one another. Even though only the foregoing components of the client device 110 are shown in FIG. 1, in other embodiments, the client device 110 may also include other suitable hardware/software components.

The network interface 112 can include a network adapter, a wireless network interface controller, and/or other suitable hardware/software configured to connect the client device 110 to the server 102 via the network 108 or other suitable networks. The user interface 118 can include a display, a touch screen, a keyboard, a track ball, and/or other suitable types of input/output components configured to accept input from and/or provide output to a user. The data store 143 can include magnetic disk storage media, optical storage media, flash memory drives, and/or other suitable persistent computer readable storage media excluding propagated signals. The data store 143 can be configured to contain records of user data 142 and the time zone rules 106 received from the server 102. The user data 142 may be stored as WebSQL, IndexDB, and/or other suitable types of data records.

As shown in FIG. 1, the client processor 111 can include a synchronizer 114 and a converter 116. In certain embodiments, at least one of the synchronizer 114 and the converter 116 may be implemented as an application-specific integrated circuit or other suitable types of hardware. In other embodiments, at least one of the synchronizer 114 and the converter 116 may be implemented as a computer program, procedure, or process written as source code in C, C++, Java, and/or other suitable programming languages. The computer program, procedure, or process may be compiled into object or machine code and presented for execution by the client processor 111. In further embodiments, both the synchronizer 114 and the converter 116 may be implemented both in hardware or software. In yet further embodiments, the client processor 111 can also include other suitable hardware/software components.

The synchronizer 114 can be configured to synchronize data between the server 102 and the client device 110. For example, the synchronizer 114 may synchronize emails, calendar events, tasks, contacts, data files, and/or other suitable user data 142 between the server 102 and the client device 110. At least a portion of the user data 142 may be time zone sensitive data with an associated data time zone. For example, an appointment date/time for a meeting in Berlin may have a designated data time zone (e.g., Central European Summer Time). As such, the appointment date/time in Berlin may be viewed as a “wall clock” that should not change even if the time keeping rules change in Germany. Other portions of the user data 142 may not have a wall clock. For example, a time stamp for an incoming email may not have an associated wall clock. Instead, the time stamp may be a reception time of the email. The synchronizer 114 may also synchronize the time zone rules 106 between the server 102 and the client device 110. In certain embodiments, the synchronizer 114 synchronizes the time zone rules 106 every time the client device 110 is connected to the server 102 via the network 108. In other embodiments, the synchronizer 114 may synchronize the time zone rules 106 periodically, on-demand, and/or based on other suitable arrangements. The synchronizer 114 can be implemented based on file synchronization, version control, distributed file systems, mirroring, and/or other suitable techniques.

The converter 116 can be configured to selectively convert time zone sensitive data received at and/or stored on the client device 110 to a target time zone based on the time zone rules 106 received from the server 102. In certain embodiments, a user may designate the target time zone via the user interface 118. In other embodiments, the client device 110 may automatically detect the target time zone based on, for example, an indication from a cellular network, a WIFI network, and/or other suitable sources. In further embodiments, the target time zone may be selected based on other suitable criteria.

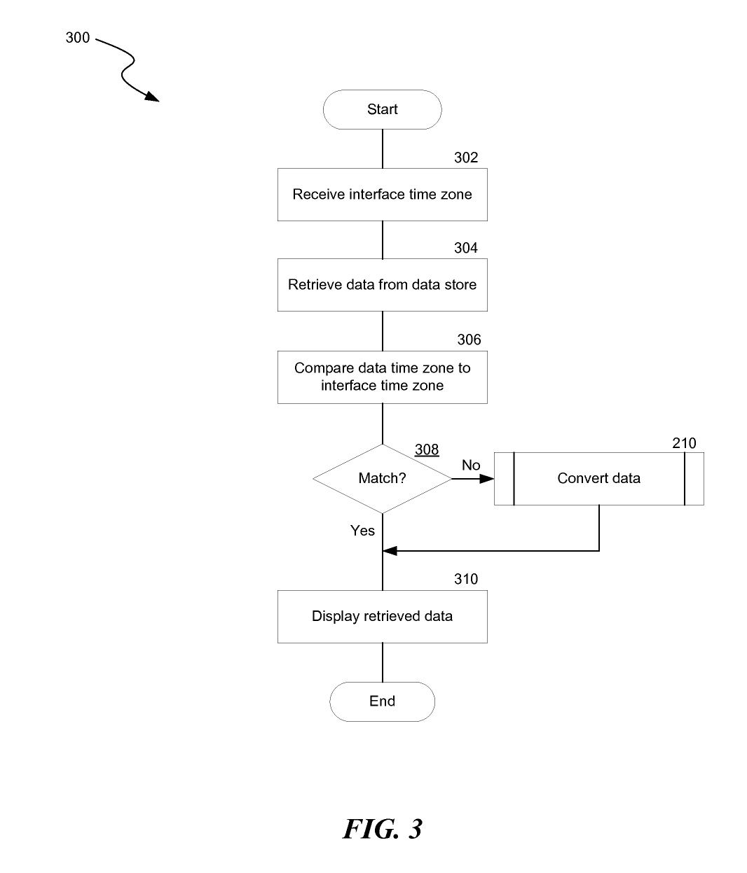

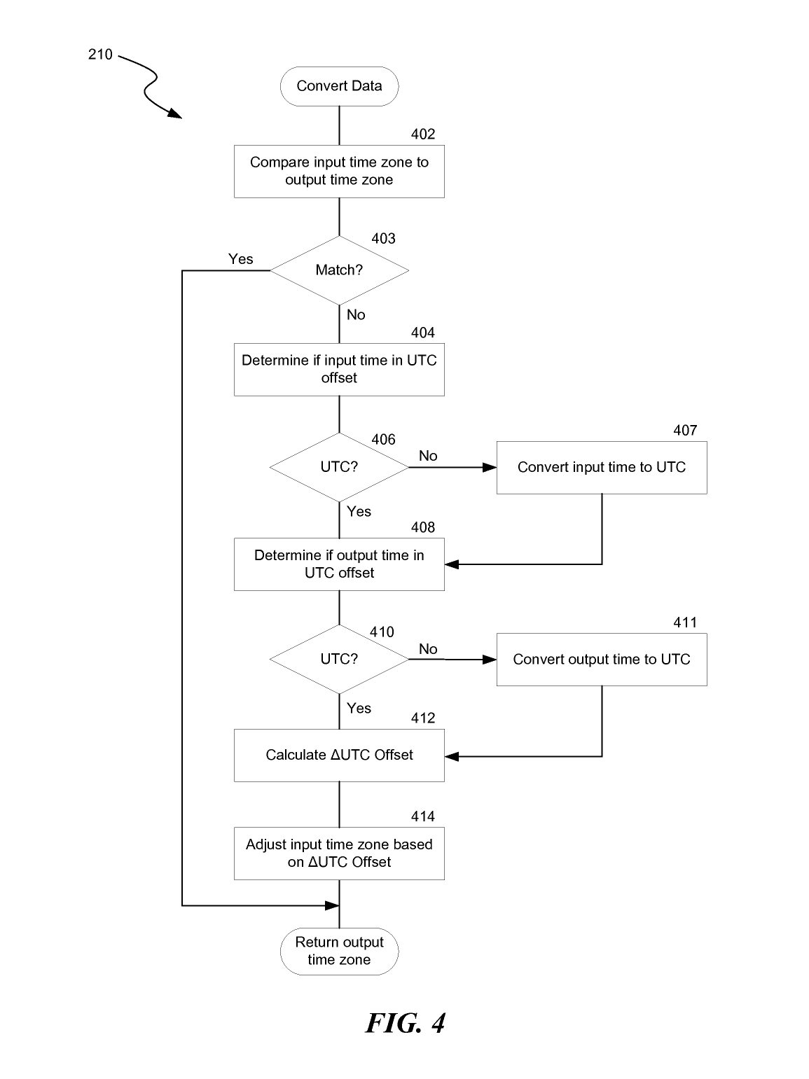

In one embodiment, the converter 116 is configured to compare the data time zone of the user data 142 received from the server 102 to the target time zone. If the time zones do not match, the converter 116 is configured to convert the received user data 142 to the target time zone based on the time zone rules 106. The converted user data 142 can then be stored in the data store 143. In other embodiments, the converter 116 may not perform the foregoing comparing and converting operations upon receiving the user data 142; instead, the received user data 142 from the server 102 may be stored in the data store 143 without time zone conversion. In another embodiment, the converter 116 is configured to compare the time zone of any stored user data 142 from the data store 143 to the target time zone. If the time zones do not match, the converter 116 is configured to convert the stored user data 142 to the target time zone based on the time zone rules 106. The converted user data 142 is then provided to the user interface 118 to be output to the user. Components and functions of the converter 116 are described in more detail below with reference to FIGS. 3 and 4.

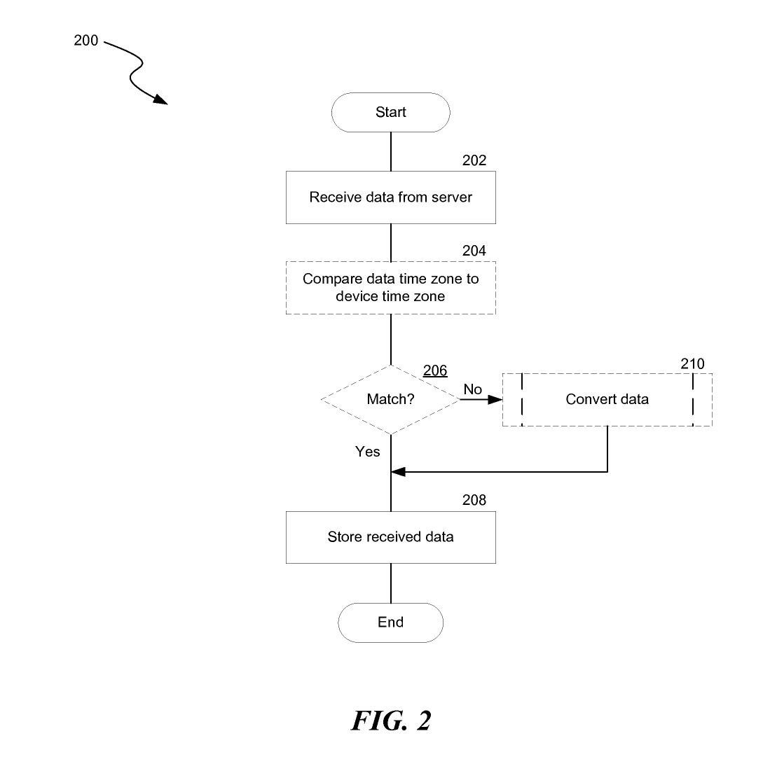

In operation, the synchronizer 114 of the client device 110 sends a request to the server 102 via the network interface 112 for synchronizing data. In response, the server 102 transmits the user data 142, the time zone rules 106, and/or other suitable data to the client device 110. The received time zone rules 106 are then stored in the data store 143. In one embodiment, the time zone rules 106 in the data store 143 are overwritten each time data is synchronized. In other embodiments, the stored time zone rules 106 may be updated based on version, date, and/or other suitable criteria. Based on the received time zone rules 106, the converter 116 of the client processor 111 may correctly convert time zone sensitive data, as described in more detail below with reference to FIGS. 2-4.

FIG. 2 is a flow diagram illustrating a process 200 for writing time zone sensitive data and time zone rules to a client device, and FIG. 3 is a flow diagram illustrating a process 300 for reading time zone sensitive data stored in the client device in accordance with embodiments of the present technology. Even though the processes 200, 300 are described below based on the computing framework 100 of FIG. 1, embodiments of the processes 200, 300 can be implemented in other suitable computing frameworks.

Referring to both FIG. 1 and FIG. 2, one stage 202 of the process 200 includes receiving data associated with a data time zone and time zone rules 106 at the client device 110 from a server (e.g., the server 102 in FIG. 1). In one embodiment, the received data can include the user data 142 from the server 102. In other embodiments, the received data can include other suitable data received from the server 102 or other servers (not shown). Another stage 204 of the process 200 can optionally include comparing the data time zone of the received user data 142 with a device time zone of the client device 110. In one embodiment, the device time zone can be a time zone associated with the data store 143. In other embodiments, the device time zone can be a time zone associated with the user interface 118 and/or other suitable time zones. At stage 206, in certain embodiments, if the data time zone matches the device time zone, the received user data 142 and time zone rules 106 may be then stored in, for example, the data store 143 without alteration. If the data time zone does not match the device time zone, the received data may be converted at stage 210, as described in more detail below with reference to FIG. 4. The converted data may be then stored at stage 208. In further embodiments, the received user data 142 and/or the time zone rules 106 may be sorted, filtered, categorized, and/or otherwise suitably processed and then stored in the data store 143.

Referring to both FIG. 1 and FIG. 3, one stage 302 of the process 300 can include receiving an indication of an interface time zone and a request for data from a user via the user interface 118 of the client device 110. For example, the user who plans to travel from New York to Berlin may choose the interface time zone as Eastern Daylight Time instead of Berlin time (e.g., Central European Summer Time) when the user is still in New York. In another example, the interface time zone may be automatically detected based on an indication from a cellular network, a WIFI network, and/or other suitable sources. At stage 304, the requested data is retrieved from the data store 143. The retrieved data has an associated data time zone (e.g., Central European Summer Time in the foregoing example).

At stage 306, the data time zone is compared to the interface time zone. At stage 308, if the time zones match or substantially similar, the retrieved data is provided to the user interface 118 without alteration at stage 310. The user interface 118 then displays the retrieved data to the user. If the time zones do not match, the received data is converted at stage 310. The converted data is then provided to the user interface 118 for outputting to the user at stage 310. In the example above, the interface time zone (i.e., Eastern Daylight Time) does not match the data time zone (i.e., Central European Summer Time). As a result, the retrieved appointment date/time is converted based on the time zone rules 106, as described in more detail below with reference to FIG. 4.

FIG. 4 is a flow diagram illustrating a process 210 for converting time stamps of time zone sensitive data in accordance with embodiments of the present technology. At stage 402, an input time zone (e.g., the data time zone of the retrieved data) is compared with a target output time zone (e.g., the interface time zone). At stage 403, if the input time zone matches the output time zone, the process returns; otherwise, the process proceeds to stage 404 for determining if the input time is expressed in UTC offset. Even though UTC offset is used as the example time scale, in other embodiments, any suitable standard time may also be used.

At stage 406, if the input time is not in UTC offset, the process 210 includes converting the input time to UTC offset based on the time zone rules 106 (FIG. 1) at stage 407. For example, the input time may be converted by locating a UTC offset in the set of time zone rules 106 for the target time zone with a start date that immediately proceeds a current date. For instance, if the target time zone is Middle East Standard Time, and the current date is Jan. 10, 2010, then, based on the example time zone rules 106 in paragraph [0017], the UTC offset with the start date (i.e., Jan. 1, 2010) immediately proceeds the current date would be 120 minutes. Thus, the UTC offset for the input time would be UTC+2 hours.

If the input time is already in UTC offset, the process proceeds to stage 408 for determining if the output time is expressed in UTC offset. At stage 410, if the output time is not expressed in UTC offset, the output time is converted to UTC offset based on the time zone rules 106 at stage 411, generally similar to converting the input time at stage 407; otherwise, the process proceeds to stage 412 for calculating a difference between the UTC offsets (ΔUTC) of the input time (UTC_{INPUT}) and the output time (UTC_{OUTPUT}) as follows:

ΔUTC=UTC_{OUTPUT}−UTC_{INPUT}

For example, if the input time is Eastern Daylight Time with a UTC offset of −4, and the output time is Central European Summer Time with a UTC offset of +2, the UTC difference between the input time and output time is 6.

At stage 414, the process 210 includes adjusting the input time (Input_Time) with the calculated difference between the UTC offsets to obtain the output time (Output_Time) as follows:

Output_Time=Input_Time+ΔUTC

Thus, in the example above, the output time of Central European Summer Time equals to the input time of Eastern Daylight Time plus 6 hours.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A computing device having time zone conversion, comprising:
a synchronizer configured to receive a set of time zone rules from a server, the set of time zone rules individually including a time zone identifier, a start date, and a time offset from a standard time beginning from the start date; and
a converter operatively coupled to the synchronizer, the converter being configured to selectively convert time zone sensitive data received at or stored on the computing device to a target time zone based on the set of time zone rules received by the synchronizer.

2. The computing device of claim 1, further comprising a user interface configured to receive an indication of the target time zone and to display the time zone sensitive data converted to the target time zone.

3. The computing device of claim 1 wherein the time offset from the standard time is updated periodically on the server.

4. The computing device of claim 1, further comprising:
a network interface configured to receive data, at least a portion of the data being time zone sensitive data associated with a data time zone;
wherein the converter is also configured to compare the data time zone to the target time zone;
if the data time zone does not match the target time zone, convert the received data to the target time zone based on the set of time zone rules received from the synchronizer; and
the computing device further includes a data store configured to store the converted time zone sensitive data.

5. The computing device of claim 1, further comprising:
a network interface configured to receive data, at least a portion of the data being time zone sensitive data associated with a data time zone;
wherein the converter is also configured to compare the data time zone to the target time zone;
if the data time zone does not match the target time zone, convert a time stamp of the time zone sensitive data based on a Coordinated Time Offset (UTC) offset in the set of time zone rules for the target time zone at or after the start date; and
the computing device further includes a data store configured to store the converted time zone sensitive data.

6. The computing device of claim 1, further comprising:
a user interface associated with the target time zone;
a data store configured to store data, at least a portion of the data being time zone sensitive data associated with a data time zone;
wherein the converter is also configured to compare the data time zone to the target time zone;
if the data time zone does not match the target time zone, convert the time zone sensitive data to the target time zone based on the set of time zone rules; and
provide the converted time zone sensitive data to the user interface to be output to a user.

7. The computing device of claim 1, further comprising:
a user interface associated with the target time zone;
a data store configured to store data, at least a portion of the data being time zone sensitive data associated with a data time zone;
wherein the converter is also configured to compare the data time zone to the target time zone;
if the data time zone does not match the target time zone, convert a time stamp of the time zone sensitive data based on a UTC offset in the set of time zone rules for the target time zone and a UTC offset in the set of time zone rules for the data time zone at or after the start date; and
provide the converted time zone sensitive data to the user interface to be output to a user.

8. A computer readable storage medium containing instructions, when executed by a processor, causing the processor to perform a method comprising:
receiving and storing a set of time zone settings, the set of time zone settings individually including at least one of a time zone name, a time change date, a time change recurrence, or an exception to the time change recurrence;
generating a set of time zone rules based on the set of time zone settings, the set of time zone rules individually including a time zone identifier, a start date, and a time offset from a standard time beginning from the start date;
receiving a request from a client device for the set of time zone rules; and
transmitting to the client device the set of time zone rules.

9. The computer readable storage medium of claim 8 wherein generating the set of time zone rules includes for each time zone associated with one of the time zone identifiers, determining a Coordinated Time Offset (UTC) offset beginning at the start date for the time zone.

10. The computer readable storage medium of claim 8 wherein generating the set of time zone rules includes:
for each time zone associated with one of the time zone identifiers, determining a UTC time beginning from the start date; and
storing the determined UTC time for each of the time zone with the corresponding start date and time zone identifier in a cache coupled to the processor.

11. The computer readable storage medium of claim 8, further comprising:
receiving an update for at least one time zones, the update including an alteration of at least one of a time change date, a time change recurrence, or an exception to the time change recurrence; and
for the at least one time zone, determining an updated UTC offset between the beginning date and the end date for the time zone.

12. The computer readable storage medium of claim 8 wherein generating the set of time zone rules includes:
for each time zone associated with one of the time zone identifiers, determining a UTC time beginning from the start date;
storing the determined UTC time for each of the time zone with the corresponding start date and time zone identifier in a cache coupled to the processor;
receiving an update for at least one time zones, the update including an alteration of at least one of a time change date, a time change recurrence, or an exception to the time change recurrence;
for the at least one time zone, determining an updated UTC offset beginning from the start date; and
updating the UTC offset for the at least one time zone in the cache with the determined updated UTC offset.

13. The computer readable storage medium of claim 8, further comprising generating the set of time zone rules based on the stored time zone settings at a startup of the processor.

14. A computer-implemented method for performing time zone conversion on a client device, the method comprising:
receiving, at the client device, a set of time zone rules from a server, the set of time zone rules individually including a time zone identifier, a start date, and a time offset from a standard time beginning from the start date;
receiving time zone sensitive data at the client device, the time zone sensitive data having a first time stamp and a first data time zone;
comparing the first data time zone of the received time sensitive data to a device time zone of the client device;
if the first data time zone does not match the device time zone, converting the first time stamp of the received time zone sensitive data to the device time zone based on the set of time zone rules received from the server;
storing the received time zone sensitive data with the converted time stamp in a database of the client device;
receiving an indication of an interface time zone and a request for data from a user via a user interface of the client device;
retrieving requested data from the database, the requested data having a second time stamp and a second data time zone;
comparing the second data time zone of the requested data to the interface time zone;
if the second data time zone does not match the interface time zone, converting the second time stamp of the requested data to the interface time zone based on the set of time zone rules received from the server; and
displaying the requested data with the converted time stamp to the user via the user interface.

15. The method of claim 14 wherein receiving the set of time zone rules includes receiving a set of Coordinated Time Offset (UTC) offsets individually having a start date for one or more time zones.

16. The method of claim 14 wherein receiving the time zone sensitive data includes receiving at least one of an appointment date, an appointment time, a task due date, an email reception time, an email send time, or a birthdate.

17. The method of claim 14 wherein:
receiving the time zone sensitive data includes receiving at least one of an appointment date, an appointment time, a task due date, an email reception time, an email send time, or a birthdate; and
comparing the first data time zone to the interface time zone includes determining if the first data time zone is represented in UTC offset;
if the first data time zone is not represented in UTC offset, converting the first data time zone to a first UTC offset;
determining if the interface time zone is represented in UTC offset;
if the interface time zone is not represented in UTC offset, converting the interface data time zone to a second UTC offset;
comparing the first and second UTC offset; and
indicating that the first data time zone matches the interface time zone if the first UTC offset matches the second UTC offset.

18. The method of claim 14 wherein:
receiving the set of time zone rules includes receiving a set of UTC offsets individually having a start date for one or more time zones;
receiving the time zone sensitive data includes receiving at least one of an appointment date, an appointment time, a task due date, an email reception time, an email send time, or a birthdate; and
comparing the first data time zone to the interface time zone includes determining if the first data time zone is represented in UTC offset;
if the first data time zone is not represented in UTC offset, converting the first data time zone to a first UTC offset based on the set of time zone rules received from the server;
determining if the interface time zone is represented in UTC offset;
if the interface time zone is not represented in UTC offset, converting the interface data time zone to a second UTC offset based on the set of time zone rules received from the server;
comparing the first and second UTC offset;
indicating that the first data time zone does not match the device time zone if the first UTC offset does not match the second UTC offset; and
converting the first time stamp includes:
calculating a difference between the first UTC offset and the second UTC offset; and
adjusting the first time stamp based on the calculated difference between the first UTC offset and the second UTC offset.

19. The method of claim 14 wherein:
the second data time zone equals the device time zone;
the interface time zone is different than the device time zone;
converting the second time stamp includes
determining if the device time zone is represented in UTC offset;
if the device time zone is not represented in UTC offset, converting the device time zone to a first UTC offset based on the set of time zone rules received from the server;
determining if the interface time zone is represented in UTC offset;
if the interface time zone is not represented in UTC offset, converting the interface data time zone to a second UTC offset based on the set of time zone rules received from the server;
calculating a difference between the first UTC offset and the second UTC offset; and
adjusting the second time stamp of the requested data based on the calculated difference between the first UTC offset and the second UTC offset.

20. The method of claim 14 wherein the set of time zone rules is a first set of time zone rules, the method further includes:
receiving a second set of time zone rules different than the first set of time zone rules; and
performing at least one of the operations below based on the second set of time zone rules:
comparing the first data time zone of the received time sensitive data to a device time zone of the client device;
if the first data time zone does not match the device time zone, converting the first time stamp of the received time zone sensitive data to the device time zone based on the set of time zone rules received from the server;
storing the received time zone sensitive data with the converted time stamp in a database of the client device;
comparing the second data time zone of the requested data to the interface time zone;
if the second data time zone does not match the interface time zone, converting the second time stamp of the requested data to the interface time zone based on the set of time zone rules received from the server; or
displaying the requested data with the converted time stamp to the user via the user interface.
